(19) United States
(12) Patent Application Publication
(10) Pub. No.: US 2014/0172530 A1
(43) Pub. Date: Jun. 19, 2014

(54) Real time on-demand coupon delivery during shopping

(71) Applicant: Jianping He, Edison, NJ (US)

(72) Inventor: Jianping He, Edison, NJ (US)

(21) Appl. No.: 13/720,939

(22) Filed: Dec. 19, 2012

(51) Int. Cl. G06Q 30/02

(52) U.S. Cl. CPC G06Q 30/0222
USPC 705/14.23

(57) ABSTRACT

The present invention provides a method, system and program product for real time on-demand coupon delivery during shopping. Consumers use built-in cameras or NFC-reader functionalities of their mobile devices to act on the tags of products they are interested in. The coupon client applications in their mobile devices capture, save and process data in the tags of products, create requests for coupons, send requests with data in the tags of products to coupon servers, fetch responses from coupon servers, save coupons in their mobile devices, and present coupons for products during checkout.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO SEQUENCE LISTING, A TABLE, OR A COMPUTER PROGRAM LISTING COMPACT DISK APPENDIX

Not Applicable

### BACKGROUND OF THE INVENTION

A coupon is an instrument to obtain discount or rebate for a type of product or service. It can be a paper certificate or a representation of digital format. Traditionally coupons are distributed through mails, newspapers or magazines. In the Internet age, a lot of coupons can be obtained from emails or websites. With the widespread use of mobile devices such as smart-phones and tablets, coupons can be downloaded or pushed into mobile devices.

During shopping, it would be very cumbersome for a consumer to bring all the paper coupons. Through communication networks, the consumer could download digital coupons into his/her mobile devices to bypass the inconvenience of paper coupons before going to stores. In addition, the consumer could pre-select coupons based on his/her planed shopping-list. However, when the consumer finds a new product or is interested in a product not in his/her planed shopping-list, he/she may wonder whether there is any coupon for the product, where and how to get it right away if there is one.

The generic issue is how to check whether there is a coupon for any product in stores, where and how to get the coupon, all in real time.

### BRIEF SUMMARY OF THE INVENTION

The present invention provides a method, system and program product for real time on-demand coupon delivery during shopping. Consumers use built-in cameras or NFC-reader functionalities of their mobile devices to act on the tags of products they are interested in. The coupon client applications in their mobile devices capture, save and process data in the tags of products, create requests for coupons, send requests with data in the tags of products to coupon servers, fetch responses from coupon servers, save coupons in their mobile devices, and present coupons for products during checkout.

### BRIEF DESCRIPTION OF THE SEVERAL VIEWS OF THE DRAWING

FIG. 1 illustrates a schematic architecture of a mobile device with a coupon client application, in accordance with one embodiment of the present invention.

FIG. 2 illustrates a schematic block diagram of a product, a coupon server, a communication network, and a mobile device with a coupon client application, in accordance with one embodiment of the present invention.

FIG. 3 illustrates a schematic sequence diagram of steps from coupon retrieval to coupon redemption, in accordance with one embodiment of the present invention.

### DETAILED DESCRIPTION OF THE INVENTION

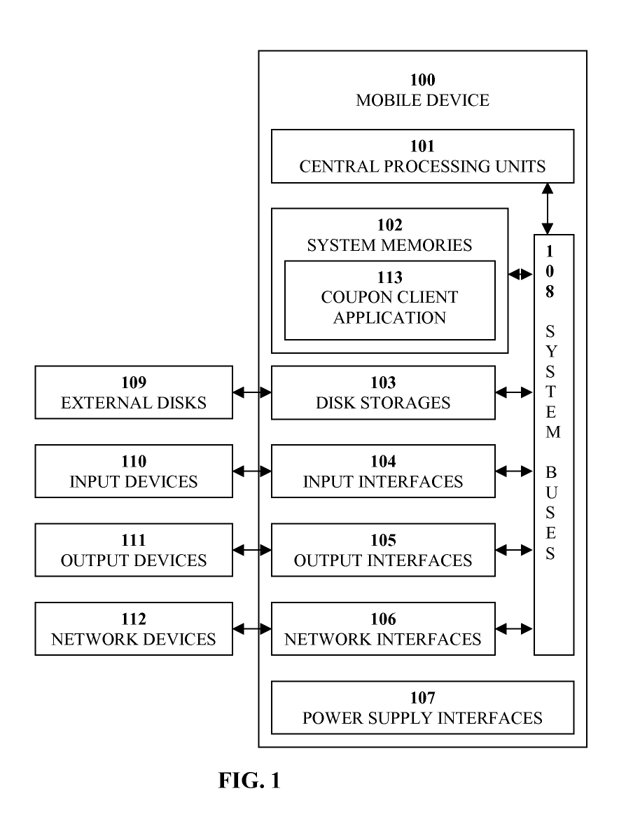

FIG. 1 illustrates a schematic architecture of a mobile device with a coupon client application. In one embodiment, the mobile device 100 comprises central processing units 101, system memories 102, disk storages 103, input interfaces 104, output interfaces 105, network interfaces 106, power supply interfaces 107, and system buses 108.

The central processing units 101 provide a means for executing executable programs and can be any types of micro-controllers, processors, micro-processors, or multi-processors. The system memories 102 provide a means for storing executable programs such as a basic input and output system (BIOS), one or more operating systems, a plurality of firmware modules, and a plurality of software or application modules. The system memories 102 can be any combinations of random-access memory and read-only memory. The coupon client application 113 is running in the system memories 102. The disk storages 103 provide a means for storing programs, files and data, and can be any types of internal disks, external disks 109, optical disks, and the like.

The input interfaces 104 provide a means for transferring data into the mobile device 100 through the input devices 110 such as keyboards, keypads, touchpads, touch screens, thumbwheels, trackballs, styluses, joysticks, microphones, cameras, sensors, etc. The input devices 110 can be internal or external parts of the mobile device 100. The output interfaces 105 provide a means for transferring data from the mobile device 100 to the output devices 111 such as screens, displays, televisions, speakers, etc. The output devices 111 can be internal or external parts of the mobile device 100.

The network interfaces 106 provide a means for transferring data between the mobile device 100 and other network devices 112 via communication networks (not shown) such as circuit-switched telephone networks or packet-switched data networks. They can be wireless interfaces such as radio interfaces with antennas, transmitters and receivers, wireless local, wide and metro area network interfaces, Near Field Communication (NFC) interfaces, and may include other wireless, wired and satellite network interfaces.

The power supply interfaces 107 provide power to the mobile device 100. They can be a number of batteries. They may include external power sources such as AC adapters.

The system buses 108 provide a means for transferring data internally among the central processing units 101, the system memories 102, the disk storages 103, the input interfaces 104, the output interfaces 105, the network interfaces 106, and other components (not shown) of the mobile device 100.

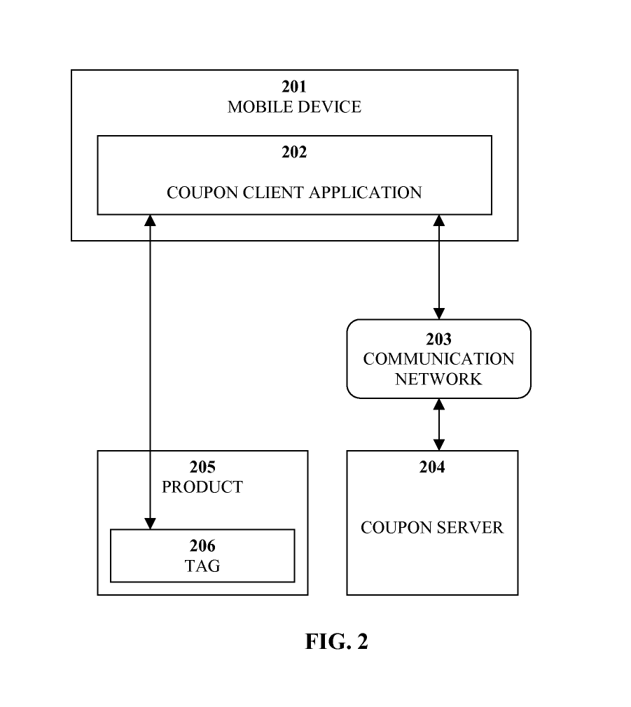

Reference is now to FIG. 2, which illustrates a schematic block diagram of a product, a coupon server, a communication network, and a mobile device with a coupon client application. In one embodiment, the coupon server 204 maintains internal or external databases of mappings between product tags and coupons. The mobile device 201 has the same architecture as the one denoted in FIG. 1. The coupon client application 202 in the mobile device 201 can utilize built-in camera in the mobile device 201 or tap the product 205 by use of NFC technology to capture the data in the tag 206 of the product 205. In addition, the coupon client application 202 in the mobile device 201 can communicate with the coupon server 204 through the communication network 203 for bi-direction data exchange.

The communication network 203 provides a means for transporting data between network data senders and network data receivers. It comprises wireless networks, zero or more of wired networks and satellite networks. Wireless networks can be one or more of wireless local area networks such as WI-FI, wireless wide area networks, wireless metropolitan area networks such as worldwide interoperability for microwave access, long term evolution networks, cellular networks such as global system for mobile communication, general packet radio service, code division multiple access, digital enhanced cordless telecommunication, integrated digital enhanced network, and the like. Wired networks can be one or more of Internet, intranets, local area networks such as ethernet, wide area networks such as frame relay and asynchronous transfer mode, virtual private networks, public switched telephone networks, and the like.

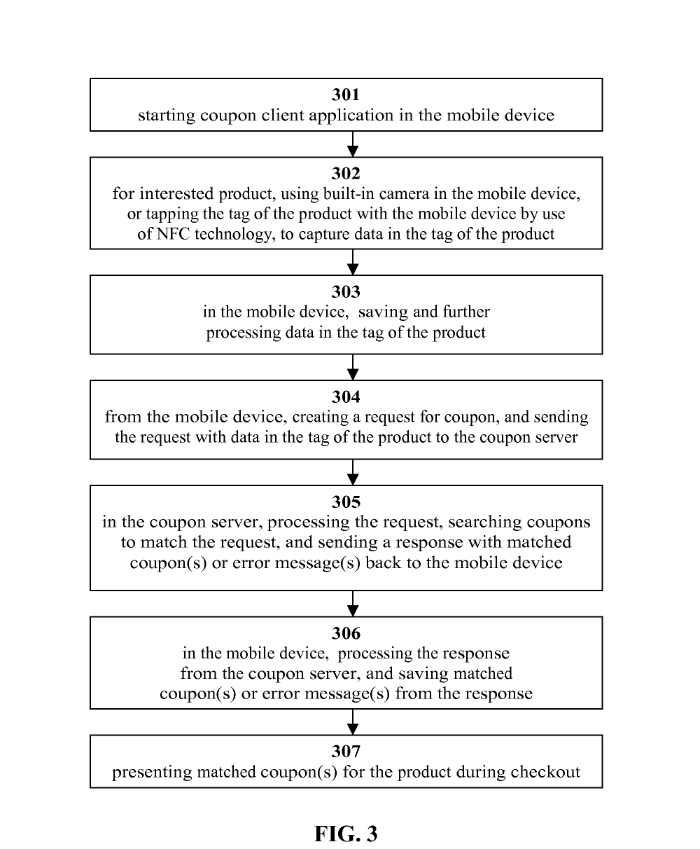

Reference is now to FIG. 3, which illustrates a schematic sequence diagram of steps from coupon retrieval to coupon redemption, in accordance with one embodiment of the present invention. During shopping, a consumer finds a particular product he/she is interested to buy. The consumer wants to check whether there is a coupon for the product, and would like to get the coupon immediately if there is one. In the first step 301, the consumer starts the coupon client application in his/her mobile device. In step 302, the consumer utilizes the built-in camera in his/her mobile device to capture data in the tag of the product if his/her mobile device has a built-in camera; or the consumer taps the tag of the product with his/her mobile device to capture data in the tag of the product by use of NFC technology if the tag of the product is a NFC-enabled tag and his/her mobile device is NFC-reader capable. In step 303, the coupon client application saves and further processes data in the tag of the product. In step 304, the coupon client application creates a request for coupon, and sends the request with data in the tag of the product to the coupon server through a communication network.

In step 305, the coupon server receives the request for coupon from the coupon client application in the mobile device, searches internal or external databases or storages for any matched coupons associated with the request, and then sends a response with either coupons if there are matches, or error messages if there is no match, back to the mobile device of the consumer through the communication network.

In step 306, the mobile device of the consumer receives the response from the coupon server through the communication network. The coupon client application in his/her mobile device processes the response, extract and save the coupons or error messages from the response. When the consumer proceeds to checkout in step 307, he/she can present fetched coupons for the product.

While the present invention has been described with respect to a limited number of embodiments, those skilled in the art will appreciate numerous modifications and variations therefrom. It is intended that the appended claims cover all such modifications and variations as fall within the true spirit and scope of the present invention.

What is claimed is:

1. A method providing real time coupon delivery for a product with a tag from a coupon server to a mobile device with a coupon client application via a communication network, the method comprising the acts:
starting said coupon client application in said mobile device;
capturing, saving and processing data in said tag by said coupon client application;
sending a request for coupon with said data from said coupon client application to said coupon server through said communication network;
receiving said request in said coupon server;
searching coupons in said coupon server to match said request;
sending a response for said request with data of matched coupon(s) or error message(s) from said coupon server to said coupon client application through said communication network;
receiving, saving and processing said response by said coupon client application;
extracting said matched coupon(s) or said error message(s) by said coupon client application;
and presenting said matched coupon(s) for said product during checkout.

2. The method as claimed in claim 1, wherein said mobile device comprises one or more of central processing units, one or more of system memories where said coupon client application can be running, one or more of wireless network interfaces, zero or more of wired and satellite network interfaces, one or more of power supply interfaces and/or batteries, one or more of output interfaces and/or output devices including display screens; zero or more of system buses, zero or more of disk storages, zero or more of input interfaces and/or input devices; wherein said communication network comprises one or more of wireless networks, zero or more of wired and satellite networks; wherein said coupon server is associated with databases of mapping between product tags and coupons, is able to search and retrieve coupons based on product tags, and can respond to said coupon client application with matched coupon(s) or error message(s) after receiving a request with data in said tag from said coupon client application through said communication network.

3. The method as claimed in claim 1, wherein said tag can be any of linear barcodes such as Universal Product Code (UPC), matrix (2-Dimension) barcodes such as Quick Response (QR) code, N-Dimension barcodes, Near Field Communication (NFC) tags, and the like; wherein capturing said data in said tag by said coupon client application can be realized through either build-in camera in said mobile device, or tapping events between said mobile device and said tag by use of NFC technology if said mobile device is NFC-reader capable and said tag is a NFC-enabled tag.

4. A system providing real time on-demand coupon delivery for a product with a tag, the system comprising:
a coupon server;
a mobile device with a coupon client application;
a communication network; and performing the acts:
starting said coupon client application in said mobile device;
capturing, saving and processing data in said tag by said coupon client application;
sending a request for coupon with said data from said coupon client application to said coupon server through said communication network;
receiving said request in said coupon server;
searching coupons in said coupon server to match said request;
sending a response for said request with data of matched coupon(s) or error message(s) from said coupon server to said coupon client application through said communication network;
receiving, saving and processing said response by said coupon client application;
extracting said matched coupon(s) or said error message(s) by said coupon client application;
and presenting said matched coupon(s) for said product during checkout.

5. The system as claimed in claim 4, wherein said mobile device comprises one or more of central processing units, one or more of system memories where said coupon client application can be running, one or more of wireless network interfaces, zero or more of wired and satellite network interfaces, one or more of power supply interfaces and/or batteries, one or more of output interfaces and/or output devices including display screens; zero or more of system buses, zero or more of disk storages, zero or more of input interfaces and/or input devices; wherein said communication network comprises one or more of wireless networks, zero or more of wired and satellite networks; wherein said coupon server is associated with databases of mapping between product tags and coupons, is able to search and retrieve coupons based on product tags, and can respond to said coupon client application with matched coupon(s) or error message(s) after receiving a request with data in said tag from said coupon client application through said communication network.

6. The system as claimed in claim 4, wherein said tag can be any of linear barcodes such as Universal Product Code (UPC), matrix (2-Dimension) barcodes such as Quick Response (QR) code, N-Dimension barcodes, Near Field Communication (NFC) tags, and the like; wherein capturing said data in said tag by said coupon client application can be realized through either build-in camera in said mobile device, or tapping events between said mobile device and said tag by use of NFC technology if said mobile device is NFC-reader capable and said tag is a NFC-enabled tag.

7. A program product comprising executable instructions embodied in readable media of a coupon server and a mobile device with a coupon client application to deliver coupons in real time for a product with a tag from said coupon server to said mobile device via a communication network, the program product comprising the acts:
starting said coupon client application in said mobile device;
capturing, saving and processing data in said tag by said coupon client application;
sending a request for coupon with said data from said coupon client application to said coupon server through said communication network;
receiving said request in said coupon server;
searching coupons in said coupon server to match said request;
sending a response for said request with data of matched coupon(s) or error message(s) from said coupon server to said coupon client application through said communication network;
receiving, saving and processing said response by said coupon client application;
extracting said matched coupon(s) or said error message(s) by said coupon client application;
and presenting said matched coupon(s) for said product during checkout.

8. The program product as claimed in claim 7, wherein said mobile device comprises one or more of central processing units, one or more of system memories where said coupon client application can be running, one or more of wireless network interfaces, zero or more of wired and satellite network interfaces, one or more of power supply interfaces and/or batteries, one or more of output interfaces and/or output devices including display screens; zero or more of system buses, zero or more of disk storages, zero or more of input interfaces and/or input devices; wherein said communication network comprises one or more of wireless networks, zero or more of wired and satellite networks; wherein said coupon server is associated with databases of mapping between product tags and coupons, is able to search and retrieve coupons based on product tags, and can respond to said coupon client application with matched coupon(s) or error message(s) after receiving a request with data in said tag from said coupon client application through said communication network.

9. The program product as claimed in claim 7, wherein said tag can be any of linear barcodes such as Universal Product Code (UPC), matrix (2-Dimension) barcodes such as Quick Response (QR) code, N-Dimension barcodes, Near Field Communication (NFC) tags, and the like; wherein capturing said data in said tag by said coupon client application can be realized through either build-in camera in said mobile device, or tapping events between said mobile device and said tag by use of NFC technology if said mobile device is NFC-reader capable and said tag is a NFC-enabled tag.
